(19) United States
(12) Patent Application Publication
(10) Pub. No.: US 2026/0279627 A1
(43) Pub. Date: Sep. 17, 2026

(54) RARE EARTH BONDED MAGNET

(71) Applicant: MINEBEA MITSUMI Inc., Nagano (JP)

(72) Inventors: Yu OKAWARA, Kitasaku-gun, Nagano (JP); Haruhiro KOMURA, Kitasaku-gun, Nagano (JP)

(21) Appl. No.: 19/168,498

(22) PCT Filed: Mar. 22, 2024
(86) PCT No.: PCT/JP2024/011184

§ 371 Date: Sep. 24, 2025

(30) Foreign Application Priority Data
Mar. 27, 2023 (JP) 2023-049910
Feb. 16, 2024 (JP) 2024-021609

(51) Int. Cl. H01F 1/057; B22F 1/05; H01F 1/055; H01F 1/059

(52) U.S. Cl. CPC H01F 1/0578; B22F 1/05; H01F 1/0558; H01F 1/059

(57) ABSTRACT

A rare earth bonded magnet includes a rare earth bonded magnet containing rare earth magnet powder and a resin cured product of a thermosetting resin. The rare earth magnet powder is isotropic Nd—Fe—B based magnet powder, the thermosetting resin is an epoxy resin, the resin cured product is contained in an amount of more than 5 wt % and 6.5 wt % or less in 100 wt % of the rare earth bonded magnet, and the rare earth bonded magnet has a porosity of less than 5%, a radial crushing strength of 60 MPa or more, and an electrical resistivity of 100 μΩ·m or more.

### TECHNICAL FIELD

The present invention relates to a rare earth bonded magnet.

### BACKGROUND ART

In recent years, rare earth permanent magnets have been applied in a wide range of fields, such as rotating devices such as motors, general household electric appliances, audio devices, medical devices, and general industrial devices, due to excellent magnetic characteristics. In particular, a rare earth bonded magnet obtained from rare earth magnet powder and a binder (resin) serving to bind the powder has a high degree of freedom in shape, and thus contributes to the miniaturization, higher performance, and the like of the above devices. As the rare earth bonded magnet, a rare earth bonded magnet containing rare earth magnet powder of Nd—Fe—B based magnet powder and a binder of an epoxy resin as a thermosetting resin has been proposed (for example, see Patent Document 1).

In the rare earth bonded magnet of Patent Document 1, Nd—Fe—B rapidly cooled magnet powder is used as rare earth magnet powder, and epoxy resins are used as resins serving as binders and are mixed in an amount of about 2.5 wt %.

In addition, when the rare earth bonded magnet is incorporated into a motor rotating at high speed, a great centrifugal force acts on a rotor attached with the rare earth bonded magnet, and the rare earth bonded magnet may be damaged and scattered. As a scattering prevention means, a configuration including a rare earth bonded magnet provided with a protective cover made of reinforced plastic has been proposed (for example, see Patent Document 2).

### CITATION LIST

### Patent Document

Patent Document 1: JP 6-314605 A
Patent Document 2: JP 8-107641 A

### SUMMARY OF INVENTION

### Technical Problem

When the rare earth bonded magnet disclosed in Patent Document 1 is provided with the protective cover made of reinforced plastic as disclosed in Patent Document 2, the rare earth bonded magnet can be prevented from scattering, while causing problems such as an increase in weight of the rotor, an increase in inertia, an increase in the number of components, and an increase in cost due to an increase in the number of mounting work processes. Therefore, the mechanical strength (radial crushing strength) of the rare earth bonded magnet needs be increased.

In addition, the rare earth bonded magnet has an advantage of high electrical resistance compared to a rare earth sintered magnet, because a resin as an insulator is present between magnet powders. However, the conventional rare earth bonded magnet containing Nd—Fe—B based magnet powder and 2 wt % to 3 wt % of resin is used by being incorporated into a motor rotating at high speed, causing problems of an increase in eddy-current loss and a decrease in motor efficiency because electrical resistance is not necessarily great. Therefore, electrical resistance needs be increased.

As described above, in the configuration using the rare earth bonded magnet containing the thermosetting resin in the motor rotating at high speed, the rare earth bonded magnet needs be further improved.

Therefore, an object of the present invention is to provide a rare earth bonded magnet having high radial crushing strength and high electrical resistance without causing a significant decrease in the magnetic characteristics of the rare earth bonded magnet.

### Solution to Problem

In order to solve the above-described problems and achieve the above-described object, a rare earth bonded magnet according to an aspect of the present invention is a rare earth bonded magnet containing rare earth magnet powder and a resin cured product of a thermosetting resin, wherein the rare earth magnet powder is isotropic Nd—Fe—B based magnet powder, the thermosetting resin is an epoxy resin, the resin cured product is contained in an amount of more than 5 wt % and 6.5 wt % or less in 100 wt % of the rare earth bonded magnet, and the rare earth bonded magnet has a porosity of less than 5%, a radial crushing strength of 60 MPa or more, and an electrical resistivity of 100 μΩ·m or more.

### Advantageous Effects of Invention

According to an aspect of the present invention, a rare earth bonded magnet having high radial crushing strength and high electrical resistance is obtained without causing a significant decrease in the magnetic characteristics of the rare earth bonded magnet.

### BRIEF DESCRIPTION OF DRAWINGS

FIG. 1 is a diagram illustrating rare earth magnet powder, a resin cured product of a thermosetting resin, and the ratio of voids (Vol %) in a rare earth magnet bond.

### DESCRIPTION OF EMBODIMENTS

Embodiments according to the present invention are described below in detail with reference to the drawings. Note that the invention is not limited to the embodiments.

Components in the following embodiments include components easily replaceable by a person skilled in the art or substantially identical components.

### First Embodiment

A rare earth bonded magnet of the first embodiment contains rare earth magnet powder and a resin cured product of a thermosetting resin. The rare earth magnet powder is isotropic Nd (neodymium)-Fe (iron)-B (boron) based magnet powder. Examples of the isotropic Nd—Fe—B based magnet powder include MQP-14-12 (trade name), MQP-8-5 (trade name), MQP-10-8.5HD (trade name), MQP-11-8 (trade name), and MQP12-8HD (trade name), manufactured by Magnequench Co., Ltd.

Alternatively, for example, the rare earth magnet powder may be Nd—Fe—B based magnet powder produced by a super-rapid cooling method. Specifically, an Nd—Fe—B based alloy is melted in high-frequency induction heating under reduced pressure or in an argon atmosphere. Subsequently, the molten metal of the melted alloy is sprayed onto a rotating roll made of copper and is subjected to super-rapid cooling (rapid quenching) to produce a ribbon-shaped thin strip. Subsequently, the thin strip is cut into pieces of, for example, about several mm to several tens mm, and then pulverized by a pulverizer or the like to obtain powder. The pulverized powder is classified using a sieve having a predetermined mesh, and then subjected to heat treatment to produce the rare earth magnet powder. Since the directions of the easy axes of magnetization of crystal grains are not aligned in one direction, the rare earth magnet powder is magnetically isotropic.

The rare earth magnet powder preferably has a particle size in a range of 45 μm or more and less than 175 μm. The particle size of the rare earth magnet powder may be in a range of 45 μm or more and less than 75 μm, and the particle size of the rare earth magnet powder may be in a range of 75 μm or more and less than 175 μm. Such a particle size range can be adjusted by classification using a sieve having a predetermined mesh.

The resin cured product of the thermosetting resin contained in the rare earth bonded magnet of the first embodiment is specifically a resin cured product of an epoxy resin. That is, the thermosetting resin is an epoxy resin.

The resin cured product is contained in an amount of more than 5 wt % and 6.5 wt % or less in 100 wt % of the rare earth bonded magnet. The rare earth magnet powder is contained in an amount of 93.5 wt % or more and less than 95 wt %. In the rare earth bonded magnet of the first embodiment, the rare earth magnet powder and the resin cured product of the thermosetting resin are preferably in a uniformly mixed state. Conventionally, in the case of producing a bonded magnet using a thermosetting resin, the binder is used in an amount of 2 wt % or more and 3 wt % or less.

The rare earth bonded magnet of the first embodiment has a porosity of less than 5%. In this way, the rare earth bonded magnet of the first embodiment contains the resin cured product of the thermosetting resin in the above amount, and thus has a low porosity and a high radial crushing strength. That is, the rare earth bonded magnet of the first embodiment has a radial crushing strength of 60 MPa or more. Moreover, the rare earth bonded magnet of the first embodiment has a low porosity and a relatively high volume ratio of the rare earth magnet powder, and thus, the deterioration of the magnetic characteristics is also suppressed.

In addition, the rare earth bonded magnet of the first embodiment has high electrical resistance because the resin cured product of the thermosetting resin is contained in the above amount. That is, the rare earth bonded magnet of the first embodiment has an electrical resistivity of 100 μΩ·m or more.

The rare earth bonded magnet of the first embodiment can be produced, for example, as follows. First, the rare earth magnet powder and the components constituting the resin cured product in the rare earth bonded magnet (raw material components of the resin cured product) are mixed at a predetermined mixing ratio to produce a compound. The mixing ratio of the rare earth magnet powder and the raw material components of the resin cured product is considered to be the same as the ratio of the rare earth magnet powder and the resin cured product in the rare earth bonded magnet after the production. Examples of the components serving as the raw materials of the resin cured product include a thermosetting resin (for example, an epoxy resin) as a binder, and a curing agent. Moreover, a small amount of a lubricant (for example, calcium stearate) may be added when the compound is produced. Specifically, the lubricant may be mixed in an amount of 0.02 wt % or more and less than 0.5 wt % with respect to a total of 100 wt % of the rare earth magnet powder and the raw material components of the resin cured product.

Subsequently, the compound is filled in the cavity of a mold and compressed by applying a predetermined pressure to produce a green body. Subsequently, the green body taken out from the mold is set in an oven and thermally cured at a predetermined temperature for a predetermined time to produce a cured body (thermal cured body) containing the rare earth magnet powder and the resin cured product. In addition, a rust-proofing means for preventing oxidation is preferably applied to the surface of the cured body. As the rust-proofing means, a known means such as electrodeposition coating or spray coating can be used. In this manner, the rare earth bonded magnet of the first embodiment is obtained.

### Second Embodiment

One of the objects of the second embodiment is to prevent a great decrease in the magnetic characteristics of the rare earth bonded magnet even when an amount of the rare earth magnet powder is small.

In order to solve the above-described problems and achieve the above-described object, a rare earth bonded magnet according to the second embodiment is a rare earth bonded magnet containing rare earth magnet powder and a resin cured product of a thermosetting resin, wherein the rare earth magnet powder is isotropic Nd—Fe—B based magnet powder, the thermosetting resin is an epoxy resin, the resin cured product is contained in an amount of more than 5 wt % and 6.5 wt % or less in 100 wt % of the rare earth bonded magnet, a particle size of the rare earth magnet powder is 45 μm or less, and a surface of the rare earth magnet powder is coated with a compound containing phosphorus. Also in the second embodiment, as in the first embodiment, the rare earth bonded magnet preferably has a porosity of less than 5%, a ring strength of 60 MPa or more, and an electrical resistivity of 100μΩ·m or more.

The rare earth magnet powder is subjected to a phosphate treatment after pulverization, so that oxidative deterioration of the magnet powder can be prevented. This can prevent a significant decrease in the magnetic characteristics of the rare earth bonded magnet.

Moreover, in the case where the above-described phosphate treatment is performed, even when the particle size of the rare earth magnet powder is set to be greater than 0 μm and equal to or less than 45 μm, the rare earth bonded magnet can be provided without preventing the magnetic characteristics of the rare earth bonded magnet from being significantly deteriorated. Moreover, the rare earth magnet powder is not limited to the Nd—Fe—B rapidly cooled magnetic powder, and may be isotropic Sm—Fe—N, anisotropic Sm—Fe—N, anisotropic Nd—Fe—B magnetic powder (trade name: d-HDDR), or SmCo magnetic powder (obtained by pulverizing anisotropic magnetic powder).

Moreover, the thermosetting resin may be a conductive epoxy resin. In this case, in an electrodeposition coating process of energizing the magnet to apply the conductive epoxy resin for rust prevention treatment, the electrodeposition coating is easily applied because the magnet itself has conductivity, and the film formability of the electrodeposition coating can be improved. The rare earth magnet powder, the resin cured product of the thermosetting resin, and the method for manufacturing the rare earth bonded magnet are the same as in the first embodiment except for the above description.

The present invention is more specifically described below based on examples, but the present invention is not limited to the examples. The following example corresponds to the first embodiment.

### EXAMPLES

### Production of Rare Earth Bonded Magnet

As the rare earth magnet powder, an isotropic Nd—Fe—B based magnet powder was used. As the isotropic Nd—Fe—B based magnet powder, MQP-14-12 (trade name) manufactured by Magnequench Co., Ltd. was prepared. The particle size of MQP-14-12 was classified into two groups: 75 μm or more and less than 150 μm and 45 μm or more and less than 75 μm. In such a case, the classification was performed using a sieve having a predetermined mesh.

Subsequently, for each of the two groups, the isotropic Nd—Fe—B based magnet powder and raw material components of a resin cured product (manufactured by Pelnox Co., Ltd and model number XW2310) containing an epoxy resin as a binder and a curing agent were mixed at a predetermined mixing ratio to produce compounds. The mixing ratio of the rare earth magnet powder and the raw material components of the resin cured product was set such that the raw material components of the resin cured product were 2.5 wt % and the rare earth magnet powder was 97.5 wt %, based on 100 wt % of the total weight. Moreover, compounds were produced when the raw material component of the resin cured product was 5 wt % and the rare earth magnet powder was 95 wt %, when the raw material component of the resin cured product was 5.5 wt % and the rare earth magnet powder was 94.5 wt %, when the raw material component of the resin cured product was 6 wt % and the rare earth magnet powder was 94 wt %, when the raw material component of the resin cured product was 6.5 wt % and the rare earth magnet powder was 93.5 wt %, and when the raw material component of the resin cured product was 7.5 wt % and the rare earth magnet powder was 92.5 wt %. The compound was produced by mixing the raw material components of the resin cured product dissolved in a solvent with the rare earth magnet powder, evaporating the solvent, and then crushing and classifying the mixture. The compounds were all produced with the same particle size, and the conditions of fluidity in filling into the cavity of a mold were the same.

Subsequently, the compound was filled in the cavity of the mold and compressed by applying a predetermined pressure (molding pressure: surface pressure of 5 ton/cm²) to produce a green body. The green body had a cylindrical shape with a diameter Φ of 10 mm and a height of 7 mm.

Subsequently, the green body taken out from the mold was set in an oven and thermally cured at a predetermined temperature (150° C.) for a predetermined time to produce a cured body (thermal cured body). The cured body had a cylindrical shape with a diameter Φ of 10 mm and a height 7 of mm. In this way, no change in size was observed between the green body and the cured body.

Subsequently, a rust-proofing means (specifically, electrodeposition coating) for preventing oxidation was applied to the surface of the cured body.

In this manner, rare earth bonded magnets (Samples 1 to 12) containing the rare earth magnet powder and the resin cured product of the thermosetting resin were produced. Samples 3 to 5 and 9 to 11 are examples and Samples 1, 2, 6, 7, 8, and 12 are comparative examples.

### Evaluation Method

### Porosity

The porosity was calculated from an apparent density relative to a true density. The evaluation criteria are as follows.
◯: Porosity is less than 5%.
Δ: Porosity is 5% or more and less than 15%.
X: Porosity is 15% or more.

### Radial Crushing Strength

The radial crushing strength was measured according to JIS Z2507. The evaluation criteria are as follows.
⊚: Radial crushing strength is 100 MPa or more.
◯: Radial crushing strength is 60 MPa or more and less than 100 MPa.
Δ: Radial crushing strength is 50 MPa or more and less than 60 MPa.
X: Radial crushing strength is less than 50 MPa.

### Electrical Resistivity

The electrical resistivity was measured using a four-point probe method. The magnet sample has a shape with a diameter Φ of 10 mm and a height of 7 mm, and the average electrical resistivity of the evaluation number N5 was obtained. The evaluation criteria are as follows.
⊚: Electrical resistivity is 100 μΩ·m or more.
◯: Electrical resistivity is 10μΩ·m or more and less than 100μΩ·m.

Δ: Electrical resistivity is less than 10μΩ·m.

### Comprehensive Evaluation

Samples 1 to 12 were subjected to comprehensive evaluation. The evaluation criteria are as follows.)
◯: Evaluation results of the radial crushing strength and the electrical resistivity are both ⊚.
X: Other than the above.

The evaluation results of Samples 1 to 12 are shown in Tables 1 and 2 below. In Table 1, “45 to 75” in the magnetic powder particle size (μm) indicates the particle size of the isotropic Nd—Fe—B based magnet powder being in a range of 45 μm or more and less than 75 μm. In Table 2, “75 to 150” in the magnetic powder particle size (μm) indicates the particle size of the isotropic Nd—Fe—B based magnet powder being in a range of 75 μm or more and less than 150 μm.

TABLE 1

| | | Amount of | | | | | |
|---|---|---|---|---|---|---|---|
| | Magnetic | raw material | | | | | |
| | powder | components | | | Radial | | |
| | particle | of resin cured | Resin | Porosity | crushing | Electrical | Comprehensive |
| Sample | size [μm] | product (wt %) | leakage | % | strength | resistivity | evaluation |
| 1: Comparative example | 45 to 75 | 2.5 | No | X | Δ | Δ | X |
| 2: Comparative example | 45 to 75 | 5 | No | ◯ | ◯ | ⊚ | X |
| 3: Example | 45 to 75 | 5.5 | No | ◯ | ⊚ | ⊚ | ◯ |
| 4: Example | 45 to 75 | 6 | No | ◯ | ⊚ | ⊚ | ◯ |
| 5: Example | 45 to 75 | 6.5 | No | ◯ | ⊚ | ⊚ | ◯ |
| 6: Comparative example | 45 to 75 | 7.5 | Yes | — | — | — | X |

Table 1 shows Samples 1 to 6, and shows the evaluation of the rare earth bonded magnets containing the isotropic Nd—Fe—B based magnet powder having a particle size in the range of 45 μm or more and less than 75 μm. In Sample 1 containing the raw material component of the resin cured product having an amount of 2.5 wt %, the porosity was 15% or more, and both the radial crushing strength and the electrical resistance (surface resistivity) were evaluated as A. This is because the amount of the raw material component of the resin cured product is substantially the same as in the conventional rare earth bonded magnet. In Sample 6 containing the raw material component of the resin cured product having an amount of 7.5 wt %, a part of the binder leaked from the cavity to cause a problem in terms of production, and thus, no evaluation was performed. This is because the amount of the raw material component of the resin cured product is too large.

The evaluation of Samples 3 to 5 other than the samples containing the raw material component of the resin cured product having an amount of 2.5 wt %, 5 wt %, and 7.5 wt % is ⊚ in all items. Therefore, the comprehensive evaluation of Samples 3 to 5 shown in Table 1 is ◯.

From the results of Table 1, it is found the radial crushing strength and the electrical resistivity increase as the porosity in the rare earth bonded magnet decreases. In samples 3 to 5 as examples, both the radial crushing strength and the electrical resistivity can be increased.

Note that, compared to Sample 1 (comparative example) containing the raw material component of the resin cured product having an amount of 2.5 wt %, since the amount of the raw material component of the resin cured product is increased in Samples 3 to 5, the filling ratio of the magnet powder is slightly decreased, but the decrease is slight compared to the magnetic characteristics of the rare earth bonded magnet of Sample 1 (comparative example) and obtaining of comparable magnetic characteristics is confirmed.

TABLE 2

| | | Amount of | | | | | |
|---|---|---|---|---|---|---|---|
| | Magnetic | raw material | | | | | |
| | powder | components | | | Radial | | |
| | particle | of resin cured | Resin | Porosity | crushing | Electrical | Comprehensive |
| Sample | size [μm] | product (wt %) | leakage | % | strength | resistivity | evaluation |
| 7: Comparative example | 75 to 150 | 2.5 | No | X | Δ | Δ | X |
| 8: Comparative example | 75 to 150 | 5 | No | ◯ | ◯ | ⊚ | X |
| 9: Example | 75 to 150 | 5.5 | No | ◯ | ⊚ | ⊚ | ◯ |
| 10: Example | 75 to 150 | 6 | No | ◯ | ⊚ | ⊚ | ◯ |
| 11: Example | 75 to 150 | 6.5 | No | ◯ | ⊚ | ⊚ | ◯ |
| 12: Comparative Example | 75 to 150 | 7.5 | Yes | — | — | — | X |

Table 2 shows Samples 7 to 12, and shows the evaluation of the rare earth bonded magnets containing the isotropic Nd—Fe—B based magnet powder having a particle size in the range of 75 μm or more and less than 150 μm. In the sample 7 containing the raw material component of the resin cured product having an amount of 2.5 wt %, the porosity was 15% or more, and both the radial crushing strength and the electrical resistance were evaluated as A. This is because the amount of the raw material component of the resin cured product is substantially the same as in the conventional rare earth bonded magnet. In Sample 12 containing the raw material component of the resin cured product having an amount of 7.5 wt %, a part of the binder leaked from the cavity to cause a problem in terms of production, and thus, no evaluation was performed. This is because the amount of the raw material component of the resin cured product is too large.

The evaluation of Samples 9 to 11 other than the samples containing the raw material component of the resin cured product having an amount of 2.5 wt %, 5 wt %, and 7.5 wt % is ⊚ in all items. Therefore, the comprehensive evaluation of Samples 9 to 11 shown in Table 2 is ◯.

From the results of Table 2, it is found the radial crushing strength and the electrical resistivity increase as the porosity in the rare earth bonded magnet decreases. In samples 9 to 11 as examples, both the radial crushing strength and the electrical resistivity can be increased.

Note that, compared to Sample 7 (comparative example) containing the raw material component of the resin cured product having an amount of 2.5 wt % as in the conventional case, since the amount of the raw material component of the resin cured product is increased in Samples 9 to 11, the filling ratio of the magnet powder is slightly decreased, but the decrease is slight compared to the magnetic characteristics of the rare earth bonded magnet of Sample 7 (comparative example) and obtaining of comparable magnetic characteristics is confirmed.

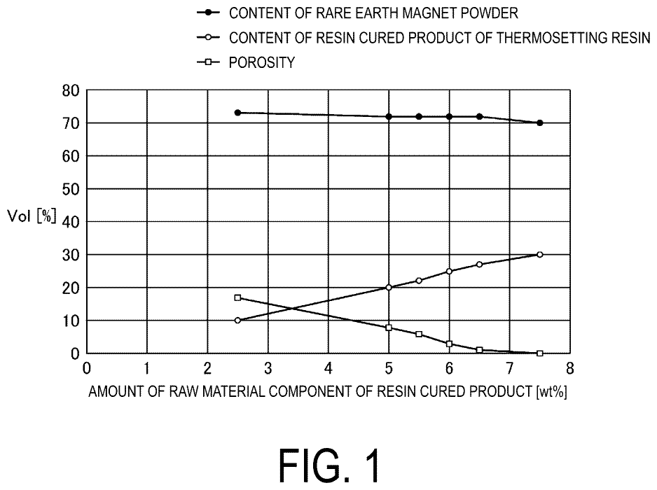

FIG. 1 is a diagram illustrating the rare earth magnet powder, the resin cured product of the thermosetting resin, and the ratio of the voids (Vol %) in the rare earth magnet bond. Specifically, Samples 1 to 6 are shown. It is found in Samples 3 to 5, the proportion of vacancies is decreased and the radial crushing strength is increased. It is found in Samples 3 to 5, the proportion of the rare earth magnet powder was hardly reduced and the deterioration of the magnetic characteristics was suppressed. The porosity was determined as follows. The true density of the experimentally produced magnet was calculated from the density 7.6 [g/cm³] of the magnetic powder and the specific gravity 0.92 [g/cm³] of the resin (including an organic solvent MEK). The volume ratio of the magnetic powder and the resin in the true density was determined, and the remainder was defined as the porosity.

1. A rare earth bonded magnet comprising:
rare earth magnet powder; and
a resin cured product of a thermosetting resin, wherein
the rare earth magnet powder is isotropic Nd—Fe—B based magnet powder,
the thermosetting resin is an epoxy resin,
the resin cured product is contained in an amount of more than 5 wt % and 6.5 wt % or less in 100 wt % of the rare earth bonded magnet, and
the rare earth bonded magnet has a porosity of less than 5%, a radial crushing strength of 60 MPa or more, and an electrical resistivity of 100 μΩ·m or more.

2. A rare earth bonded magnet comprising:
rare earth magnet powder and a resin cured product of a thermosetting resin, wherein
the thermosetting resin is an epoxy resin,
the resin cured product is contained in an amount of more than 5 wt % and 6.5 wt % or less in 100 wt % of the rare earth bonded magnet,
a particle size of the rare earth magnet powder is 45 μm or less, and
a surface of the rare earth magnet powder is coated with a compound containing phosphorus.

3. The rare earth bonded magnet according to claim 2, wherein
the rare earth magnet powder is isotropic Nd—Fe—B based magnet powder.

4. The rare earth bonded magnet according to claim 2, wherein
the rare earth magnet powder is anisotropic Nd—Fe—B based magnet powder.

5. The rare earth bonded magnet according to claim 2, wherein
the rare earth magnet powder is isotropic Sm—Fe—N based magnet powder.

6. The rare earth bonded magnet according to claim 2, wherein
the rare earth magnet powder is anisotropic Sm—Fe—N based magnet powder.

7. The rare earth bonded magnet according to claim 2, wherein
the rare earth magnet powder is anisotropic SmCo based magnet powder.

8. The rare earth bonded magnet according to claim 2, wherein
the epoxy resin has conductivity.
